(19) United States
(12) Patent Application Publication
(10) Pub. No.: US 2026/0120972 A1
(43) Pub. Date: Apr. 30, 2026

(54) METHOD FOR DETERMINING AN ESTIMATED TRAVEL CURVE OF AN INTERRUPTER UNIT, AND INTERRUPTER UNIT FOR A GAS-INSULATED HIGH OR MEDIUM VOLTAGE DEVICE

(71) Applicant: Hitachi Energy Ltd, Zürich (CH)

(72) Inventor: Kenneth BRYAR, White Oak, PA (US)

(21) Appl. No.: 19/469,804

(22) PCT Filed: Mar. 29, 2023
(86) PCT No.: PCT/EP2023/058187

§ 371 Date: Sep. 26, 2025

(51) Int. Cl. H01H 11/00; H01H 1/00; H01H 9/00; H01H 33/12

(52) U.S. Cl. CPC H01H 11/0062; H01H 1/0015; H01H 9/0066; H01H 33/12

(57) ABSTRACT

The invention relates to a computer implemented method for determining an estimated travel curve of an interrupter unit of a high or medium voltage device, including the steps of—receiving a reference travel curve for the interrupter unit of the high or medium voltage device, wherein the reference travel curve describes relative positions of arcing contacts of the interrupter unit with regard to each other over time during an opening and/or closing operation of the interrupter unit, receiving auxiliary switch data representing transition timepoints of an auxiliary switch A and transition timepoints of an auxiliary switch B of the interrupter unit during opening and/or closing operation, wherein the auxiliary switch data has been acquired by performing multiple opening and/or closing operations of the interrupter unit, and determining an estimated travel curve by taking the received reference travel curve and the received auxiliary switch data into account.

### CROSS-REFERENCE TO RELATED APPLICATIONS

This application is a 35 U.S.C. § 371 national stage application of International Application No. PCT/EP2023/058187 filed on Mar. 29, 2023, the disclosure and content of which are incorporated by reference herein in their entireties.

### TECHNICAL FIELD

The disclosure relates to a computer implemented method for determining an estimated travel curve of an interrupter unit of a high or medium voltage device.

The present disclosure also relates to a data processing apparatus comprising a processor configured to perform the above method.

Furthermore, the disclosure also relates to a computer-readable medium comprising instructions which, when executed by a computer, cause the computer to carry out the above method.

The disclosure further relates to an interrupter unit for a high or medium voltage device comprising the above data processing apparatus.

### BACKGROUND ART

High or medium voltage devices, such as circuit breakers and switchgears are essential for the protection of technical equipment, especially in the high voltage range. For example, circuit breakers are predominantly used for interrupting a current, when an electrical fault occurs. As an example, circuit breakers have the task of opening arcing contacts, quench an arc, and keeping the arcing contacts apart from one another in order to avoid a current flow even in case of high electrical potential originating from the electrical fault itself. Circuit breakers may break medium to high short circuit currents of typically 1 kA to 80 kA at medium to high voltages of 12 kV to 72 kV and up to 1200 kV. Thus, high or medium voltage devices accommodate high-voltage conductors such as conductors to which a high voltage is applied.

The component of a circuit breaker or switchgear designed to make or break the current is called interrupter unit. During the service life of the high or medium voltage device the interrupter unit is subject to wear, in particular due to the electric arc that builds between the arcing contacts when breaking current. An electric arc is made up by a flux of electrons and a flux of ions which circulate in opposite directions between the arcing contacts. The wear of the interrupter unit accumulates during arcing and may change the operational characteristics of the interrupter unit and/or of the high or medium voltage device.

In order to provide a condition- and/or reliability-based maintenance of the high or medium voltage device one key parameter for analysis is the motion of the arcing contact during operation of the interrupter unit, called the travel curve. The travel curve can be used to calculate critical parameters that represent the health of the interrupter unit and/or of the high or medium voltage device. For example, from the travel curve it can be determined when the arcing contacts engage or separate. Furthermore, the travel curve can be used to determine when other parts of the interrupter unit such as a nozzle is subjected to arcing as this is a function of the position of the arcing contacts. It is also possible to determine the wear of the interrupter unit based on analysis of the travel curve and other parameters such as the current through the high or medium voltage device. For example, interrupter wear algorithms calculate or at least approximate the wear of the interrupter unit based on the travel curve and the current. Thus, the travel curve is an important characteristic for determining the health of the interrupter unit and for providing condition- and/or reliability-based maintenance.

One option to determine the travel curve is to incorporate microprocessor controlled on-line condition monitoring devices and sensors into the high or medium voltage device for on-line data acquisition of the travel curve. An example of such a sensor is a contact travel sensor. Such a sensor is capable of tracking the position of the arcing contacts of the interrupter unit as they move from open to closed positions, and vice versa, with a resolution of about 0.1 mm-1.0 mm and a sample period of typically 0.1 ms-0.3 ms.

However, the use of sensors and/or devices for on-line condition monitoring poses various technical and economic challenges. Even though such sensors are commercially available, their successful installation in a high or medium voltage device is non-trivial, as the mounting locations for these sensors to pick up linear and/or rotary motion, in particular motion which is proportional to or at least unambiguously linked to the motion of the arcing contacts to be measured, is either not accessible or not weather protected.

Even if a suitable mounting location for such an on-line sensor is identified and the necessary mounting provisions engineered, the sensor arrangement should be life-tested for at least 2000 interrupter unit operations to ensure that the mounting and/or the sensor will not fail during its intended service life. Life testing of a sensor installation is thus only economical during the prototyping phase of a new high or medium voltage device model.

As the installation of microprocessor controlled on-line condition monitoring devices and/or sensors is often economically or technically not feasible, other methods have been developed to determine the travel curve. These other methods are based on the simulation of the travel curve.

The knowledge about the time values corresponding to the state transitions of switches between closed and open states—also called normally open switch transition point, and a normally closed switch transition point—may come from monitoring auxiliary switches that are mechanically linked to the arcing contacts and that close and open consistent with the separation or engagement of the arcing contacts. Examples of such auxiliary switches include, but are not limited to, A and B switches. An A switch closes during a close operation after the arcing contacts have traveled about 70% towards their end-position, and a B-switch opens during a close operation after the arcing contacts have traveled about 30% towards their end-position. The exact values of the transition positions are dependent on the specific interrupter unit and may be determined by off-line testing of the specific interrupter unit. The A-switch opens and the B-switch closes during an open operation. The typical use of auxiliary switches is for control schemes and for remote indication of the arcing contacts. Because the latter function is fundamental to the operation of high or medium voltage devices, high or medium voltage devices are equipped with auxiliary switches as standards components.

To simulate a travel curve, the normally open switch transition point, and the normally closed switch transition point on the travel curve to be simulated may need to be known. Each point consists of an ordered pair of position information and time information—i.e. the relative position of the arcing contacts with regard to each other and a specific timepoint, when this position is reached during the operation of the interrupter unit.

However, to acquire the knowledge about the normally open switch transition point, and the normally closed switch transition point on the travel curve for the simulation of the travel curve has been proven to be challenging in actual field use. Off-line testing used for determining the transition position of the auxiliary switches is done with high precision. However, in normal use of the interrupter unit auxiliary switches often operate with variance, so while the transition position is captured off-line, these results may not be representative of normal operations. Using the transition positions determined by off-line testing for simulating the travel curve can result in poorly estimated travel curves. This may cause inaccuracies in reporting of key parameters, and/or nuisance alarms generated due to incorrect settings.

Furthermore, the transition positions of the auxiliary switches are not always determined by off-line testing, and thus not always known. In such a situation there is not enough information for simulating the travel curve, which leads to extended outage times to repeat tests.

### SUMMARY

It is an object of the disclosure to provide means to improve and/or simplify the simulation of a travel curve.

The object of the disclosure is solved by the features of the independent claims. Modified embodiments are detailed in the dependent claims.

Thus, the object is solved by a computer implemented method for determining an estimated travel curve of an interrupter unit of a high or medium voltage device, comprising the steps of
Receiving a reference travel curve for the interrupter unit of the high or medium voltage device, wherein the reference travel curve describes relative positions of arcing contacts of the interrupter unit with regard to each other over time during an opening and/or closing operation of the interrupter unit,
Receiving auxiliary switch data representing transition timepoints of an auxiliary switch A and transition timepoints of an auxiliary switch B of the interrupter unit during opening and/or closing operation, wherein the auxiliary switch data has been acquired by performing multiple opening and/or closing operations of the interrupter unit,
Determining a sample mean, a sample variance, and/or a sample standard deviation of the received auxiliary switch data, and
Determining an estimated travel curve by a curve fitting process and by taking the received reference travel curve and the received auxiliary switch data into account.

It was found that simulating the travel curve can be simplified and the accuracy of the estimated travel curve can be enhanced when the simulation process takes the reference travel curve into account. The reference travel curve can be an actual measured travel curve, or the reference travel curve can be a hypothetical travel curve. The reference travel curve can be specific for different interrupter unit models, meaning that the shape of the reference travel curve may be different for different models of interrupter units. Furthermore, it is preferred to use an actual measured travel curve as reference travel curve, for example a travel curve that has been measured with the same interrupter unit model, as this gives higher accuracies for the estimated travel curve determined by the above method.

It was further found that the accuracy of the estimated travel curve can be enhanced when auxiliary switch data that has been acquired during multiple opening and/or closing operations of the specific interrupter unit, for which the estimated travel curve shall be determine, is taken into account. Acquiring the auxiliary switch data by multiple operations assures that the auxiliary switch data is representative for the interrupter unit during normal operation. In particular, the variance of the operation of the auxiliary switches is represented by the received auxiliary switch data. This preferably also means that the specific transition timepoints of the auxiliary switch A and specific transition timepoints of the auxiliary switch B may not have the same value for each performed operation.

According to a preferred embodiment of the disclosure, the estimated travel curve is determined by the curve fitting process, such that the determined estimated travel curve best fits the received reference travel curve under consideration of the received auxiliary switch data. In other words, the method uses the curve fitting process for determining the estimated travel curve. This makes it possible given the variance of the auxiliary switch data to evaluate the various different values of the transition timepoints of the auxiliary switch A and the transition timepoints of the auxiliary switch B and to determine the best combination.

According to a further preferred embodiment of the disclosure, the estimated travel curve is automatically determined and/or the estimated travel curve is determined without the need of user input. In particular, the step of determining the estimated travel curve by taking the received reference travel curve and the received auxiliary switch data into account does preferably not need any further information except for the received reference travel curve and the received auxiliary switch data in order to be executed. Thus, a fully automated travel curve estimation is possible, saving time and costs.

According to another preferred embodiment of the disclosure the estimated travel curve is determined by taking a predetermined travel curve model into account. The predetermined travel curve model is preferably a mathematical model representing an assumption how the travel curve should look like. For example, the predetermined travel curve model can make sure that a course of the estimated travel curve to be determined by the method is linear between the transition timepoints of the auxiliary switch A and the auxiliary switch B. Furthermore, the predetermined travel curve model can for example make sure that the estimated travel curve to be determined by the method is continuous and differentiable in all points. Other courses or properties of the estimated travel curve to be determined by the method can be assured by the travel curve model.

According to another preferred embodiment of the disclosure, the estimated travel curve is determined based on a closed contact position, a fully open contact position, an auxiliary switch A transition position, and an auxiliary switch B transition position. In other words, to simulate the travel curve, preferably four specific data points on the travel curve to be simulated may need to be known. The four specific data points are the closed contact position, the fully open contact position, the auxiliary switch A transition position, and the auxiliary switch B transition position.

Each auxiliary switch transition position can be part of an auxiliary switch transition point, which preferably comprises an ordered pair of position information—i.e. the auxiliary switch transition position—and time information.

The closed contact position is preferably the relative positions of the arcing contacts at the end of a closing operation and/or at the start of an opening operation. The fully open contact position is preferably the relative positions of the arcing contacts at the end of an opening operation and/or at the start of a closing operation.

Further preferably, the closed contact position and the fully open contact position are determined by taking the reference travel curve into account. In this regard and according to another preferred embodiment of the disclosure, the method comprises the step of determining a distance travelled by the arcing contacts between the closed contact position and the fully open contact position by analyzing the received reference travel curve. In particular the received reference travel curve is preferably analyzed to determine the distance—i.e. the absolute difference between the closed contact position and the fully open contact position. Further preferably, either the closed contact position or the fully open contact position is defined as having a value of zero. Thus, in other words by analyzing the received reference travel curve for determining the distance travelled by the arcing contacts, the closed contact position and the fully open contact position are determined.

It is further possible to analyze the received reference travel curve with regard to time information. Preferably, the timepoint associated with the closed contact position of the reference travel curve may be determined, the timepoint associated with the fully open contact position of the received reference travel curve may be determined and/or the timepoint associated with the start of a movement of the arcing contacts may be determined from the received reference travel curve. The timepoint associated with the start of movement of the arcing contacts may be the same as a reaction time, which indicates the time from initiation of an opening and/or closing command until the arcing contacts start to move.

With regard to the received auxiliary switch data and according to another preferred embodiment of the disclosure, a method is provided, wherein the received auxiliary switch data comprises at least one transition timepoint of an auxiliary switch A and at least one transition timepoint of an auxiliary switch B for each performed opening and/or closing operation of the interrupter unit, and wherein the method comprises the step of determining for each transition timepoint of the auxiliary switch A and for each transition timepoint of the auxiliary switch B of the received auxiliary switch data a corresponding transition position of the arcing contacts by taking the received reference travel curve into account. Further preferably for determining the corresponding transition position further predetermined information may be taken into account. For example, as further information assumed transition positions for the arcing contacts may be taken into account, preferably as starting values for the curve fitting process. During the curve fitting process, these values then change in while being optimized. Furthermore, as further information a timepoint of initiation of the opening and/or closing command is preferably taken into account when determining the corresponding transition positions. The timepoint of initiation of the opening and/or closing command is preferably the first timepoint of the received auxiliary switch data and/or the received reference travel curve.

As mentioned above, the received reference travel curve is preferably analyzed with regard to position information. On the other hand, the received auxiliary switch data preferably comprises time information. From this position and time information and based on the received reference travel curve the method preferably assigns the position information of each auxiliary switch transition—i.e. the auxiliary switch A transition position, and the auxiliary switch B transition position.

It is possible that the received auxiliary switch data consists of individual datapoints specifying the transition timepoints of the auxiliary switch A and the transition timepoints of the auxiliary switch B. However, it is preferred that the auxiliary switch data comprises a timeseries. In this regard and according to another preferred embodiment of the disclosure the received auxiliary switch data comprises a state of the auxiliary switch A and a state of the auxiliary switch B over time during the opening and/or closing operation of the interrupter unit, and the method comprises the step of determining at least one transition timepoint of the auxiliary switch A and at least one transition timepoint of the auxiliary switch B for each performed opening and/or closing operation of the interrupter unit by pattern recognition and/or by a machine learning based approach.

In other words, the received auxiliary switch data preferably describes the state of the auxiliary switch A and the state of the auxiliary switch B over the time of the opening and/or closing operation of the interrupter unit for each of the performed multiple opening and/or closing operations as timeseries. The method preferably automatically determines based on the timeseries for each performed operation the transition timepoint of the auxiliary switch A and the transition timepoint of the auxiliary switch B.

In this regard it is further preferred that the determination of the at least one transition timepoint of the auxiliary switch A and at least one transition timepoint of the auxiliary switch B for each performed opening and/or closing operation can be performed with different types of learning modes. For example, it may be possible that a user selects a type of a learning mode for determining the transition timepoint of the auxiliary switch A and the transition timepoint of the auxiliary switch B from the received auxiliary switch data.

Once the estimated travel curve is determined by the method, important parameters can be derived from the estimated travel curve. These parameters are for example the reaction time, which is the time from initiation of the opening and/or closing command until the arcing contacts start to move; arcing contact velocity at a specific timepoint of the opening and/or closing operation or arcing contact velocity at a specific relative position of the arcing contacts, wherein the arcing contact velocity is the slope of the estimated travel curve at a specific point of the estimated travel curve; and mechanism time, which is the time from initiation of the opening and/or closing operation until an arcing contact position is reached, where the arcing contacts engage or separate to make or break current.

According to the disclosure, the method comprises the step of determining a closed contact timepoint, a fully open contact timepoint, and/or a reaction time based on the determined estimated travel curve. Further preferably the closed contact timepoint, the fully open contact timepoint and/or the reaction time are determined for each performed opening and/or closing operation of the interrupter unit. It is further preferred that the determined closed contact timepoint, the fully open contact timepoint and/or the reaction time is compared to the timepoint associated with the closed contact position of the reference travel curve, the timepoint associated with the fully open contact position of the reference travel curve, and/or the reaction time determined from the reference travel curve, that all may have been determined by analysis of the reference travel curve.

According to another preferred embodiment of the disclosure, the method comprises the step of determining an alignment score between the determined estimated travel curve and the received reference travel curve. The alignment score can represent how closely the determined estimated travel curve aligns with the received reference travel curve. The alignment score may for example be a sum of squared residuals.

According to another preferred embodiment of the disclosure, the method comprises the step of determining a sample mean, a sample variance, and/or a sample standard deviation of the received auxiliary switch data. As the auxiliary switch data has been acquired by performing multiple opening and/or closing operations of the interrupter unit, the variability of the transition timepoint of the auxiliary switches can be determined. The variance and other statistical indicators can be used to form a data validity index based on repeatability.

The estimated travel curve may or may not represent the real arcing contact position over time of the specific interrupter unit for which the estimated travel curve is determined. However, the determined estimated travel curve represents a possible and useful travel curve for the interrupter unit that provides the end-user with the appearance of a recorded travel curve. As noted above, the determined estimated curve allows for determining various parameters such as reaction time, contact velocity, mechanism time. Furthermore, the determined estimated travel curve can be used by interrupter wear algorithms to calculate or at least approximate the wear of the interrupter unit and can be used for a condition- and/or reliability-based maintenance of the interrupter unit and/or the high or medium voltage device.

Other aspects and advantages of the method for determining the estimated travel curve of the interrupter unit of the high or medium voltage device are directly and unambiguously derived by the person skilled in the art from the description of the data processing apparatus, the computer readable medium, the interrupter unit, and the figure description.

As already mentioned, the disclosure is also directed to the data processing apparatus comprising a processor configured to perform the above-described method.

Furthermore, the disclosure is also directed to an interrupter unit for a high or medium voltage device comprising the above data processing apparatus.

The disclosure further relates to a computer-readable medium comprising instructions which, when executed by a computer, cause the computer to carry out the above-described method.

The data processing apparatus may be integrated into the interrupter unit and/or the high or medium voltage device. Alternatively, the data processing apparatus may be remote from the interrupter unit and/or the high or medium voltage device.

The data processing apparatus may be configured as a computer. However, it is also possible that the data processing apparatus is configured as microprocessor, as on-line condition motoring system and/or as other component of the interrupter unit or as other component of the high or medium voltage device.

The processor of the data processing apparatus may receive the reference travel curve and the auxiliary switch data, e.g. from a memory or from a transient memory of the data processing apparatus. It is also possible that the processor of the data processing apparatus may receive the reference travel curve from a server. Furthermore, the auxiliary switch data may be received by the processor from an auxiliary switch data acquiring module of the interrupter unit.

With regard to the interrupter unit and according to a further preferred embodiment of the disclosure, the interrupter unit comprises an auxiliary switch A and an auxiliary switch B, wherein the auxiliary switch A is configured to transition from an open state to a closed state during a closing operation of the interrupter unit and wherein the auxiliary switch B is configured to transition from a closed state to an open state during a closing operation of the interrupter unit, and wherein the interrupter unit is configured to send auxiliary switch data representing transition timepoints of the auxiliary switch A and transition timepoints of the auxiliary switch B of the interrupter unit during opening and/or closing operation to the data processing apparatus.

For acquiring and/or sending auxiliary switch data to the data processing apparatus, the interrupter unit may comprise an auxiliary switch data acquiring module.

The A switch of the interrupter unit preferably closes during a closing operation of the interrupter unit and the B-switch preferably opens during a closing operation of the interrupter unit. Further preferably the A-switch opens during an opening operation of the interrupter unit and the B-switch closes during an opening operation of the interrupter unit.

With regard to the interrupter unit, it is further preferred that the interrupter unit further comprises a first arcing contact and a second arcing contact, and wherein
a) for an opening operation of the interrupter unit at least one of the arcing contacts is axially movable along a switching axis thereby bringing the first arcing contact and the second arcing contact from a closed position with direct contact between the first and second arcing contacts into an open position with a distance between the first and second arcing contacts, and/or
b) for a closing operation of the interrupter unit at least one of the arcing contacts is axially movable along a switching axis thereby bringing the first arcing contact and the second arcing contact from an open position with a distance between the first and second arcing contacts into a closed position with direct contact between the first and second arcing contacts.

The interrupter unit is preferably an interrupter unit for a gas-insulated high or medium voltage device. The gas-insulated high or medium voltage device is preferably a circuit breaker or a switchgear Furthermore, in the context of this disclosure medium to high voltages means voltages of 12 kV to 72 kV (medium voltage) and up to 1200 kV (high voltage).

These and other aspects of the disclosure will be apparent from and elucidated with reference to the embodiments described hereinafter.

In the drawings:

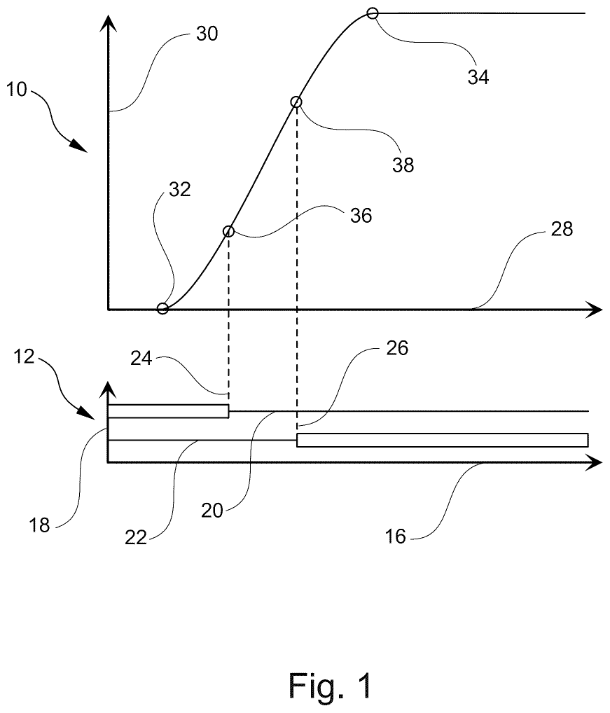

FIG. 1 schematically shows a reference travel curve and auxiliary switch data that are used in a method for determining an estimated travel curve according to a preferred embodiment of the disclosure, and

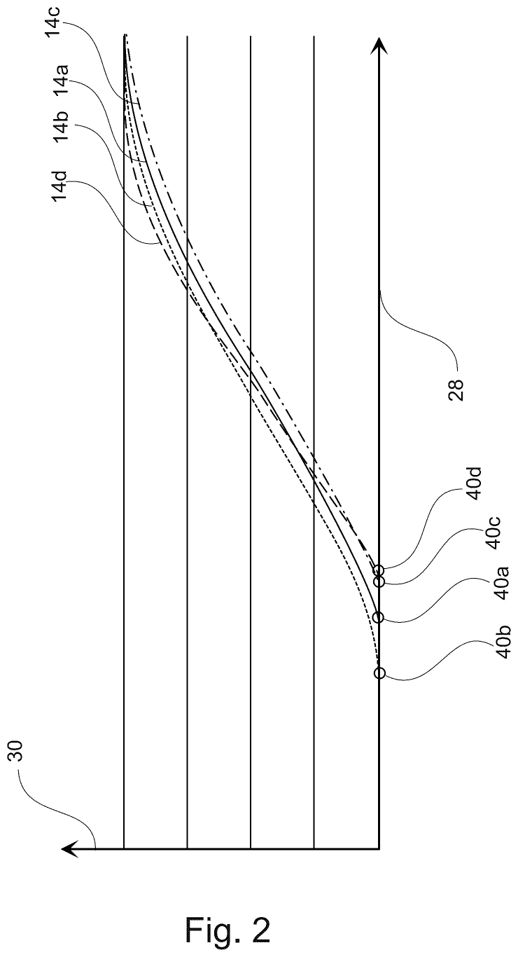

FIG. 2 schematically shows several estimated travel curves determined by the method for determining an estimated travel curve according to a preferred embodiment of the disclosure.

### DESCRIPTION OF EMBODIMENTS

FIG. 1 schematically shows a reference travel curve 10 and auxiliary switch data 12 that are used in a method for determining an estimated travel curve 14 (not shown in FIG. 1) according to a preferred embodiment of the disclosure. The method is performed by a processor of a data processing apparatus.

In the method for determining the estimated travel curve 14, the reference travel curve 10 is received by the processor. Furthermore, auxiliary switch data 12 representing transition timepoints 24 of an auxiliary switch A and transition timepoints 26 of an auxiliary switch B of the interrupter unit during opening and/or closing operation is received by the processor, wherein the auxiliary switch data 12 has been acquired by performing multiple opening and/or closing operations of the interrupter unit.

FIG. 1 does not show the whole auxiliary switch data 12 which is received by the processor, but only auxiliary switch data 12 that has been acquired by performing one closing operation of the interrupter unit.

In a next step of the method the estimated travel curve is determined by taking the received reference travel curve and the received auxiliary switch data into account. In this embodiment the estimated travel curve is determined by a curve fitting process, such that the determined estimated travel curve best fits the received reference travel curve 14 under consideration of the received auxiliary switch data 12.

With regard to the auxiliary switch data 12 shown in FIG. 1, the x-axis 16 describes the time, while the y-axis 18 describes the state 20 of the auxiliary switch A and the state 22 of the auxiliary switch B. As can be seen in the auxiliary switch data 12 represented in FIG. 1, during the operation of the interrupter unit, the auxiliary switch A and the auxiliary switch B transition from a first state (shown in the figure by the empty rectangle) into a second state (shown in the figure by a line) and vice versa. As the auxiliary switch A transitions from an open state (empty rectangle) into a closed state (line) and the auxiliary switch B transitions from a closed state (line) into an open state (empty rectangle), the operation of the interrupter unit during the acquisition of this auxiliary switch data 12 was a closing operation.

The transition timepoint 24 of the auxiliary switch A as well as the transition timepoint 26 of the auxiliary switch B are also indicated in FIG. 1. In this embodiment the received auxiliary switch data 12 not only represents the transition timepoints 24 of the auxiliary switch A and the transition timepoint 26 of the auxiliary switch B of the interrupter unit during the closing operation but comprises the state of the auxiliary switch A and a state of the auxiliary switch B over time during the closing operation of the interrupter unit as timeseries. The processor determines at least one transition timepoint 24 of the auxiliary switch A and at least one transition timepoint 26 of the auxiliary switch B for each performed opening and/or closing operation of the interrupter unit by pattern recognition, in an automatic fashion.

With regard to the reference travel curve 10 shown in FIG. 1, as this is a closing operation, the received reference travel curve 10 describes relative positions of arcing contacts of the interrupter unit with regard to each other over time during a closing operation of the interrupter unit. The x-axis 28 of the diagram with the reference travel curve 10 describes the time, while the y-axis 30 describes the relative position of the arcing contacts of the interrupter unit with regard to each other.

For determining the estimated travel curve 14, the processor analyzes the received reference travel curve 10. In particular, the method comprises the step of determining a distance travelled by the arcing contacts between a closed contact position 34 and a fully open contact position 32 by analyzing the received reference travel curve 10.

As can be seen in FIG. 1, the reference travel curve comprises a fully open contact position 32 and a closed contact position 34. The fully open contact position 32 is the relative positions of the arcing contacts at the beginning the closing operation. In this embodiment it is defined that the fully open contact position 32 has a value of zero.

The closed contact position 34 is the relative positions of the arcing contacts at the end of the in the closing operation. In this particular embodiment, by analysis of the received reference travel curve 10 it was found that the closed contact position 34 has a value of 200 mm.

For determining the estimated travel curve 14, the processor also determines for each transition timepoint 24 of the auxiliary switch A and for each transition timepoint 26 of the auxiliary switch B of the received auxiliary switch data 12 a corresponding transition position 36, 38 of the arcing contacts. This is achieved by taking the reference travel curve 10 into account.

FIG. 2 schematically shows several estimated travel curves 14a, 14b, 14c, 14d determined by the method for determining an estimated travel curve according to a preferred embodiment of the disclosure. The x-axis 28 of the diagram in FIG. 2 describes the time, while the y-axis 30 describes the estimated relative position of the arcing contacts of the interrupter unit with regard to each other.

As explained above the auxiliary switch data 12 has been acquired by performing multiple opening and/or closing operations of the interrupter unit and the processor determines a transition timepoint 24 of the auxiliary switch A and a transition timepoint 26 of the auxiliary switch B for each performed opening and/or closing operation and further for each transition timepoint 24 of the auxiliary switch A and for each transition timepoint 26 of the auxiliary switch B a corresponding transition position 36, 38 of the arcing contacts.

Thus, several values for the transition position 36 of the auxiliary switch A and for the transition position 38 of the auxiliary switch B are determined. These values are shown in the following table 1. Furthermore, the values for the fully open contact position 32 and the closed contact position 34 found by analysis of the received reference travel curve 10 are also indicated in table 1:

TABLE 1
Parameters used for determination of estimated travel curves in FIG. 2

| | fully open | transition | transition | closed | |
|---|---|---|---|---|---|
| | contact | position of | position of | contact | |
| Estimated | position/ | the auxiliary | the auxiliary | position/ | Reaction |
| travel curve | mm | switch A/mm | switch B/mm | mm | time/ms |
| 14a | 0 | 65 | 180 | 200 | 41.7 |
| 14b | 0 | 55 | 170 | 200 | 34.5 |
| 14c | 0 | 72 | 190 | 200 | 48.9 |
| 14d | 0 | 55 | 190 | 200 | 50.1 |

Based on these four values, four different estimated travel curves 14a, 14b, 14c, 14d are determined. Table 1 also indicates a reaction time 40a, 40b, 40c, 40d, which corresponds to the time information indicated in FIG. 2 for each simulated travel curve 14. The reaction time 40 was determined based on the determined estimated travel curve 14.

By comparing the determined estimated travel curves 14a, 14b, 14c, 14d to the reference travel curve 10, the estimated travel curve 14 that best fits the received reference travel curve 10 can be determined.

While the disclosure has been illustrated and described in detail in the drawings and foregoing description, such illustration and description are to be considered illustrative or exemplary and not restrictive; the disclosure is not limited to the disclosed embodiments. Other variations to be disclosed embodiments can be understood and effected by those skilled in the art in practicing the claimed disclosure, from a study of the drawings, the disclosed, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting scope.

### REFERENCE SIGNS LIST

10 reference travel curve
12 auxiliar switch data
14 estimated travel curve
16 x-axis of auxiliar switch data, time information
18 y-axis of auxiliar switch data
20 state of auxiliary switch A over time
22 state of auxiliary switch B over time
24 transition timepoint of auxiliary switch A
26 transition timepoint of auxiliary switch B
28 x-axis of reference travel curve/estimated travel curve, time information
30 y-axis of reference travel curve/estimated travel curve, position information
32 fully open contact position
34 closed contact position
36 transition position of the auxiliary switch A
38 transition position of the auxiliary switch B
40 reaction time

1-15. (canceled)

16. A computer implemented method for determining an estimated travel curve of an interrupter unit of a high or medium voltage device, comprising the steps of:
receiving a reference travel curve for the interrupter unit of the high or medium voltage device, wherein the reference travel curve describes relative positions of arcing contacts of the interrupter unit with regard to each other over time during an opening and/or closing operation of the interrupter unit,
receiving auxiliary switch data representing transition timepoints of an auxiliary switch A and transition timepoints of an auxiliary switch B of the interrupter unit during opening and/or closing operation, wherein the auxiliary switch data has been acquired by performing multiple opening and/or closing operations of the interrupter unit,
determining a sample mean, a sample variance, and/or a sample standard deviation of the received auxiliary switch data, and
determining an estimated travel curve by a curve fitting process and by taking the received reference travel curve and the received auxiliary switch data into account.

17. The computer implemented method according to claim 16, wherein the estimated travel curve is determined by the curve fitting process, such that the determined estimated travel curve best fits the received reference travel curve under consideration of the received auxiliary switch data.

18. The computer implemented method according to claim 16, wherein the estimated travel curve is automatically determined and/or wherein the estimated travel curve is determined without the need of user input.

19. The computer implemented method according to claim 16, wherein the estimated travel curve is determined by taking a predetermined travel curve model into account, and/or wherein the estimated travel curve is determined based on a closed contact position, a fully open contact position, an auxiliary switch A transition position, and an auxiliary switch B transition position.

20. The computer implemented method according to claim 16, wherein the method comprises the step of determining a distance travelled by the arcing contacts between a closed contact position and a fully open contact position by analyzing the received reference travel curve.

21. The computer implemented method according to claim 16, wherein the received auxiliary switch data comprises at least one transition timepoint of an auxiliary switch A and at least one transition timepoint of an auxiliary switch B for each performed opening and/or closing operation of the interrupter unit, and
wherein the method comprises the step of determining for each transition timepoint of the auxiliary switch A and for each transition timepoint of the auxiliary switch B of the received auxiliary switch data a corresponding transition position of the arcing contacts by taking the received reference travel curve into account.

22. The computer implemented method according to claim 16, wherein the received auxiliary switch data comprises a state of the auxiliary switch A and a state of the auxiliary switch B over time during the opening and/or closing operation of the interrupter unit, and
wherein the method comprises the step of determining at least one transition timepoint of the auxiliary switch A and at least one transition timepoint of the auxiliary switch B for each performed opening and/or closing operation of the interrupter unit by pattern recognition and/or by a machine learning based approach.

23. The computer implemented method according to claim 16, wherein the method comprises the step of determining a closed contact timepoint, a fully open contact timepoint, and/or a reaction time based on the determined estimated travel curve.

24. The computer implemented method according to claim 16, wherein the method comprises the step of determining an alignment score between the determined estimated travel curve and the received reference travel curve.

25. A data processing apparatus comprising a processor configured to perform the method according to claim 16.

26. A computer-readable medium comprising instructions which, when executed by a computer, cause the computer to carry out the method according to claim 16.

27. An interrupter unit for a high or medium voltage device comprising a data processing apparatus according to claim 25.

28. The interrupter unit according to claim 27, wherein the interrupter unit comprises an auxiliary switch A and an auxiliary switch B, wherein the auxiliary switch A is configured to transition from an open state to a closed state during a closing operation of the interrupter unit and wherein the auxiliary switch B is configured to transition from a closed state to an open state during a closing operation of the interrupter unit,
wherein the interrupter unit is configured to send auxiliary switch data to the data processing apparatus, and wherein the auxiliary switch data represents transition timepoints of the auxiliary switch A and transition timepoints of the auxiliary switch B of the interrupter unit during opening and/or closing operation.

29. The interrupter unit according to claim 28, wherein the interrupter unit further comprises a first arcing contact and a second arcing contact, and wherein:
for an opening operation of the interrupter unit at least one of the arcing contacts is axially movable along a switching axis thereby bringing the first arcing contact and the second arcing contact from a closed position with direct contact between the first and second arcing contacts into an open position with a distance between the first and second arcing contacts, and/or
for a closing operation of the interrupter unit at least one of the arcing contacts is axially movable along a switching axis thereby bringing the first arcing contact and the second arcing contact from an open position with a distance between the first and second arcing contacts into a closed position with direct contact between the first and second arcing contacts.
